(19) United States
(12) Patent Application Publication
(10) Pub. No.: US 2001/0037289 A1
(43) Pub. Date: Nov. 1, 2001

(54) Methods and systems of identifying, processing and credit evaluating low-moderate income populations and reject inferencing of credit applicants

(76) Inventors: Mona Mayr, Naperville, IL (US); Stephen Wright, St. Charles, IL (US)

Correspondence Address: George T. Marcou, Esq., Kilpatrick Stockton LLP, Suite 900, 607 14th Street, N.W., Washington, DC, 20005, US

(21) Appl. No.: 09/815,221

(22) Filed: Mar. 22, 2001

Related U.S. Application Data
(60) Provisional application No. 60/199,944, filed on Apr. 27, 2000.
(60) Provisional application No. 60/200,116, filed on Apr. 27, 2000.

(51) Int. Cl. G06F 17/60

(52) U.S. Cl. 705/38

(57) ABSTRACT

A method and system for low-moderate income scoring utilizes census tract and MSA median income information relative to applicants addresses to initially classify applicants as low-moderate, and for applicants with established credit bureau histories, to classify applicants as low-moderate income, to enable forecasting credit characteristics of applicants as part of a homogeneous population of low-moderate income individuals. A reject inferencing aspect creates reject inferencing for financial institution credit applicant scorecard development utilizing anonymized archived credit bureau information relative to a reject decision and a follow-up profile of the reject's credit performance with other creditors to empirically determine from the archived credit bureau information whether the reject should be classified as a good or bad for scorecard development.

### PRIORITY APPLICATION

This application claims the benefit of U.S. Provisional Application No. 60/199,944 filed Apr. 27, 2000 and entitled “Method and System of Identifying, Processing and Credit Evaluating Low-Moderate Income Populations (Low-Moderate Income Scoring)” and U.S. Provisional Application No. 60/200,116 filed Apr. 27, 2000 and entitled “Method and System for Reject Inferencing of Credit Applicants (Reject Inferencing),” each of which is incorporated herein by this reference.

### FIELD OF THE INVENTION

The present invention relates generally to the field of evaluation of creditworthiness of customers of a financial institution, such as a bank, including scorecard model development, and more particularly to a method and system of identifying, processing and credit evaluating low-moderate income persons and retroactively analyzing the credit performance of previously rejected applicants for use in building more predictive score models.

### BACKGROUND OF THE INVENTION

A problem that financial institutions, such as banks, currently have, for example, is how to handle the predominant population of applicants for credit that a financial institution has that represent a low-moderate income population out of the financial institution's total applicant population pool. The problem of dealing with the predominance of low-moderate income applicants in relation to the total population represents a challenge for the financial institution's business, because the population of low-moderate income persons can be, for example, a significant percentage of the financial institution's applicants and can contain distinctly different predictive credit bureau characteristics when compared to those associated with non-low-moderate income people.

To date, there has been no systemically effective method of identifying this specialized population of low-moderate income people to determine whether they could be more ‘fairly’ and accurately evaluated for credit. In order to protect against biased credit evaluations of specialized population groups in the current environment without the advantage of segregating to their benefit, manual second level review processes have been created. The manual second level processes are subjective and time consuming. The creation of a systemic process to facilitate the identification and credit evaluation of particular population groups not only improves the ability of those groups to be judged based on their own unique characteristics, but also provides a more rapid method of consistent credit evaluation thus reducing operating costs and ensuring consistent, ‘fair’ evaluation procedures.

A financial institution that is, for example, a chartered bank in the U.S. typically does business in all types of markets and is also responsible for taking applications from a wide spectrum of people of different economic status. In that regard, one of the things that historically has been said by different consumer groups representing different populations of U.S. citizens of different economic strata is that all such populations have somewhat unique characteristics about the way they handle and manage credit. This invention provides a methodology for identifying different economic groups and enabling separate creditworthiness evaluation where appropriate.

Another current problem for financial institutions, such as banks, is how to accurately include the characteristics associated with previously rejected applicants when a financial institution develops new scorecards for credit applicants. Traditionally, financial institutions must make some inferences about previously rejected applicants (using more up-to-date data) and attempt to determine which of those applicants that were declined in the past would have, if booked, been creditworthy or non-creditworthy. Reject inferencing may be critical to scorecard model development, but has traditionally been performed based on assumptions and profile associations rather than known subsequent credit performance.

### SUMMARY OF THE INVENTION

It is a feature and advantage of the present invention to provide a method and system for identifying, processing and credit evaluating low-moderate income populations that affords an improved analytical tool developed on a homogeneous population.

It is another feature and advantage of the present invention to provide a method and system for identifying, processing and credit evaluating low-moderate income populations which focuses on analyzing various credit bureau characteristics of different types of groups of applicants.

It is a further feature and advantage of the present invention to provide a method and system for identifying, processing and credit evaluating low-moderate income populations that affords a powerful predictive tool which includes a more objective and less subjective approach in evaluating whether a customer is likely to perform well or poorly based on their own unique characteristics.

It is an additional feature and advantage of the present invention to provide a method and system for retroactively analyzing the credit performance of credit applicants that furnishes a better overall way of designing, building new models and forecasting the likelihood that a loan will become good, delinquent or a collection problem.

It is a further feature and advantage of the present invention to provide a method and system for retroactively analyzing the credit performance of credit applicants which utilizes retrospective knowledge of how previously rejected persons actually performed with various other creditors.

It is another feature and advantage of the present invention to provide a method and system for retroactively analyzing the credit performance of credit applicants which allows the specific financial institution to obtain such information for scorecard developmental purposes while maintaining anonymity of the applicants and other creditors.

It is an additional feature and advantage of the present invention to provide a method and system for retroactively analyzing the credit performance of credit applicants that affords a more objective approach with known performance, which does not involve a subjective judgment in the evaluation of whether an applicant would have performed well or not, and therefore provides more predictive scorecard models.

To achieve the stated and other features, advantages and objects, an embodiment of the present invention provides a method and system for identifying and creating low-moderate credit evaluations which focuses on analyzing various credit bureau characteristics of different types of groups of applicants. An embodiment of the present invention provides a powerful predictive tool which includes a more objective and less subjective approach in evaluating whether a customer is likely to perform well or poorly based on their own unique characteristics. Another aspect of an embodiment of the present invention provides a method and system for retroactively analyzing the credit performance of credit applicants, which utilizes retrospective knowledge of how previously rejected persons actually performed with various other creditors. A critical component of this aspect allows the specific financial institution to obtain such information for scorecard developmental purposes while maintaining anonymity of the applicants and other creditors. This aspect provides a more objective approach with known performance, which does not involve a subjective judgment in the evaluation of whether an applicant would have performed well or not, and therefore provides more predictive scorecard models.

The method and system for an embodiment of the present invention makes use of computer hardware and computer software, for example, to enable a financial institution, such as a bank, to identify, process and credit evaluate low-moderate income populations. In an embodiment of the present invention, the financial institution receives residence address information for one or more applicants, which includes, for example, a nine digit postal zip code number. The system for an embodiment of the present invention utilizes the address information, such as the nine digit postal zip code number, to identify a predefined geographic functional area, such as a Metropolitan Statistical Area (“MSA”), and a predefined statistical subdivision of the functional area, such as a census tract within the MSA, that corresponds to the residence address information and to ascertain a median income for each one.

If the applicant's income is unknown at this stage, the system for an embodiment of the present invention compares the median income for the statistical subdivision or census tract to the median income for the geographic functional area or MSA that correspond to the applicant's residence address information. If the median income for the census tract is equal to or less than a predefined percentage, such as 80 percent, of the median income for the MSA, the applicant is classified as low-moderate income, and the system sets a low-moderate income indicator flag to “YES.” However, if the applicant's income is known, the system compares the applicant's income to the median income for the geographic functional area or MSA that corresponds to the applicant's residence address information. If the applicant's income is equal to or less than a predefined percentage, such as 80 percent, of the median income for the MSA, the applicant is classified as low-moderate income, and the system likewise sets the low-moderate income indicator flag to “YES.” In an embodiment of the present invention, various credit characteristics of one or more applicants classified as low-moderate income can be forecast according to predefined parameters for a homogeneous population of low-moderate income credit applicants.

In an additional aspect of the system and method for an embodiment of the present invention, inferences of various credit characteristics, referred to as reject inferences, can be derived for one or more applicants classified as low-moderate income from a comparison of characteristics of other applicants to whom credit was extended by the financial institution in the past versus those characteristics associated with previously rejected applicants of the financial institution to whom credit was subsequently extended by other creditors. In the reject inference aspect of an embodiment of the present invention, the financial institution provides a credit bureau, for example, via a third party service provider, with a sample of identifiers for previously rejected applicants of the financial institution for a predefined period of time when the applicants were rejected. The credit bureau identifies first archived credit bureau information for the nearest point in time to when the applicants were rejected and second archived credit bureau information relative to a profile of the credit performance of the previously rejected applicants with the other creditors. The first and second archived credit bureau information is returned to the financial institution, for example, via the third party service provider, with identifiers removed for anonymity of the previously rejected applicants. The anonymized information is used to empirically determine whether the previously rejected applicants subsequently maintained good credit with the other creditors.

Additional objects, advantages and novel features of the invention will be set forth in part in the description which follows, and in part will become more apparent to those skilled in the art upon examination of the following, or may be learned by practice of the invention.

### BRIEF DESCRIPTION OF THE DRAWINGS

FIG. 1 is a schematic diagram which illustrates an example of high level system interface architecture which imbeds an embodiment of the present invention;

FIG. 2 is a flow chart which shows an example of use of the census tract method for identifying low-moderate income applicants for credit for an embodiment of the present invention;

FIG. 3 is a table which shows an example of LMI flag determination for the census tract method for identifying low-moderate income applicants for credit for an embodiment of the present invention;

FIG. 4 is a flow chart which illustrates an example of the process of identifying, processing and credit evaluating a low-moderate income applicant for an embodiment of the present invention;

FIG. 5 is a chart which shows an example of scorecard population split rationale for the census tract method for identifying low-moderate income applicants for credit for an embodiment of the present invention;

FIG. 6 is a chart which shows an example of final scorecard population splits for the census tract method for identifying low-moderate income applicants for credit for an embodiment of the present invention;

FIG. 7 is a table which shows high level detail regarding description of methodologies associated with reject inferencing technologies for an embodiment of the present invention;

FIG. 8 is a flow chart which illustrates an example of the process of retroactively analyzing the credit performance of a credit applicant for an embodiment of the present invention; and

FIG. 9 is a chart which shows high level detail regarding comparison of traditional methodology for reject inferencing to the methodology for reject inferencing for an embodiment of the present invention.

### DETAILED DESCRIPTION

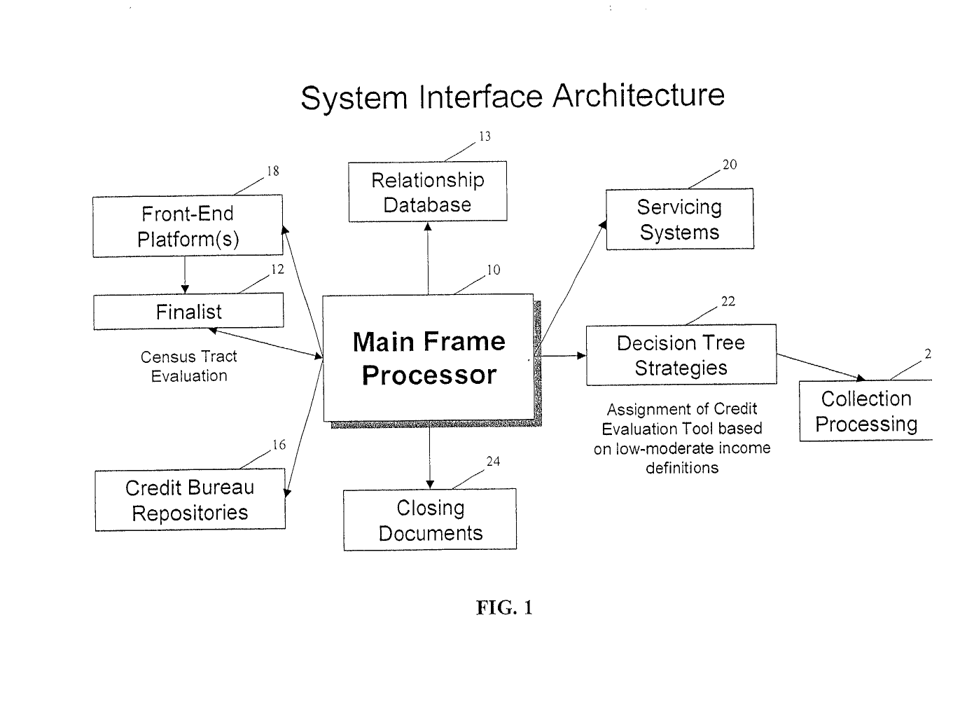

Referring now in detail to an embodiment of the present invention, an example of which is illustrated in the accompanying drawings, FIG. 1 is a schematic diagram which illustrates an example of high level system interface architecture which imbeds an embodiment of the present invention. Components of the system interface architecture for an embodiment of the present invention include, for example, a main frame processor 10, computer software, such as the “Finalist” software 12, front end platforms 14, credit bureau repositories 16, a relationship database 18, servicing systems 20, decision tree strategies 22, closing documents 24, and collection processing 26. An important aspect of an embodiment of the present invention is how to make the model work, for example, within an existing mainframe process in an ‘on-line’ environment, which involves the use of computer software, such as the “Finalist” software 12, and determining how best to integrate its ability to identify specified census tracts appropriately into the decisioning process.

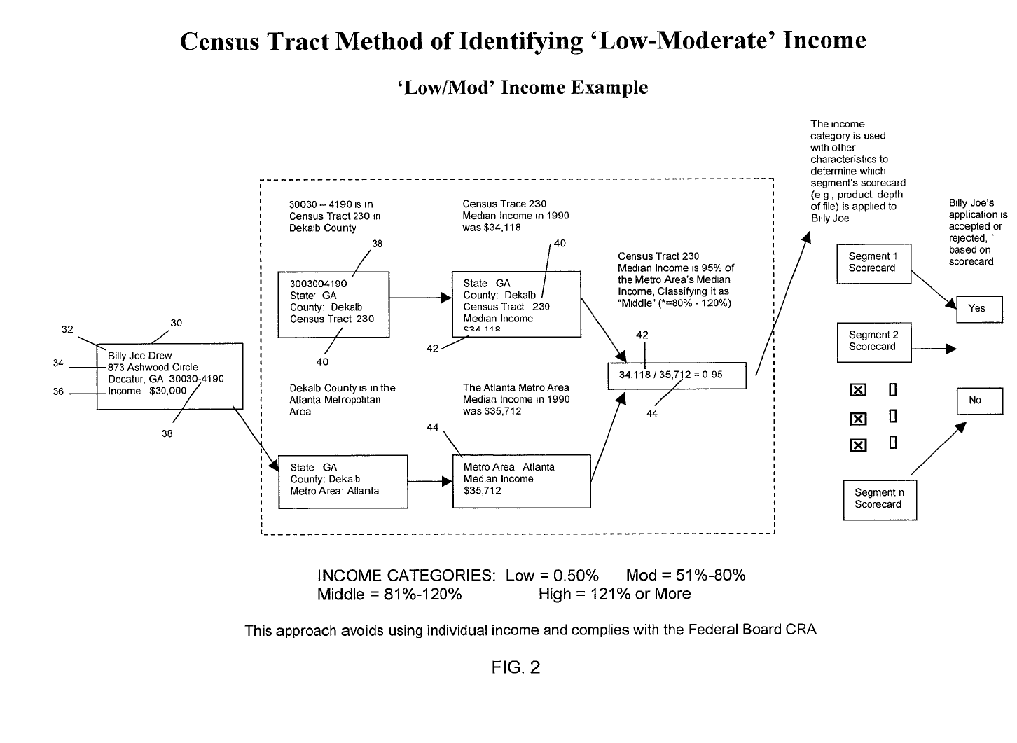

An embodiment of the present invention makes use, for example, of a census tract approach which utilizes computer software such as the “Finalist” software 12, to assign a “zip plus 4” (nine digit zip code) to the financial institution's applicant population. FIG. 2 is a flow chart which shows an example of use of the census tract method for identifying low-moderate income applicants for credit for an embodiment of the present invention. Referring to FIG. 2, which illustrates a somewhat conceptual but accurate representation of how the census tract approach works, an applicant comes in and may or may not provide the financial institution with the applicant's income. However, the applicant provides the financial institution all of its identifiers 30, such as name 32, address 34, SSN, and/or date of birth, at least in terms of being able to get to a credit report. The financial institution may or may not have the applicant's income 36 at that time. Once the applicant provides his or her address, including “zip plus 4” 38, the financial institution automatically knows the applicant's census tract 40. Once the financial institution knows the census tract 40, it can then compare the census tract median income 42 to the Metropolitan Statistical Area (“MSA”) median income 44.

The process of comparing the census tract median income 42 to the MSA median income 44 for an embodiment of the present invention involves the financial institution actually computing whether or not the census tract median income 42 is less than 80% of the MSA median income 44. In doing that, the financial institution classifies the account as either low-moderate or non-low-moderate, at least at this stage, using government published information. The 80% methodology is something that is used as a matter of credit policy by the banking industry in general. Thus, the financial institution has the benefit here of the immediate access to MSA median income 44. The financial institution has the census tract median income 42 accessible almost instantaneously through the financial institution's system. That is because the financial institution creates a lookup table that, once the applicant enters in the information, for example, in the financial institution's retail branch, it enables processing system servicing of the financial center to make the split on whether or not the applicant is a low-moderate applicant. Another high level comment for an embodiment of the present invention is that the financial institution has an additional step for people that are non-low-moderate. In that case, the financial institution looks at the credit bureau information in more detail, and applicant groups are then split into additional population groups that have separate scorecards.

Another aspect built-in to an embodiment of the present invention is that the financial institution also realizes that it has a population of applicants that make very little income but live, for example, in quite upscale economic areas (based on census tract definition). In the cases where an applicant does not have a deep credit history or much use of credit and does not have a high income, the financial institution systemically reclassifies that applicant based on established policies. The financial institution reassesses the low-moderate split to compare the applicant's income to the MSA median income and makes another check to see whether or not the applicant qualifies for the low-moderate scorecards. Thus, the financial institution actually gives lower income applicants another chance to qualify for low-moderate treatment and consideration. This specialized classification is done to ensure that if applicants are truly defined as low-moderate income, they will be evaluated with credit evaluating models defined to their specific homogeneous group, thus providing them with the best opportunity to obtain credit.

In scorecard selection for an embodiment of the present invention, the first thing the financial institution checks is to confirm that the applicant has a credit bureau history that is sufficiently robust that the financial institution can actually score the applicant and thereby predict credit performance. Thus, the terms ‘established’ or ‘non-established’ are used in reference to issues such as, whether or not the applicant has enough trades, whether or not the applicant has been in file long enough, whether or not the applicant has some trades that are open more than a year. The financial institution attempts to confirm that the applicant also has a credit bureau report, and many times applicants do not have a credit bureau report. In cases where applicants end up as ‘non-established’, the financial institution does not actually apply the low-moderate splits or scorecards to them. In those cases, the financial institution actually relies more on decision tree evaluating procedures or judgmental underwriting process, which is similar to what is done today when the financial institution is not able to obtain a rich credit bureau history on an applicant.

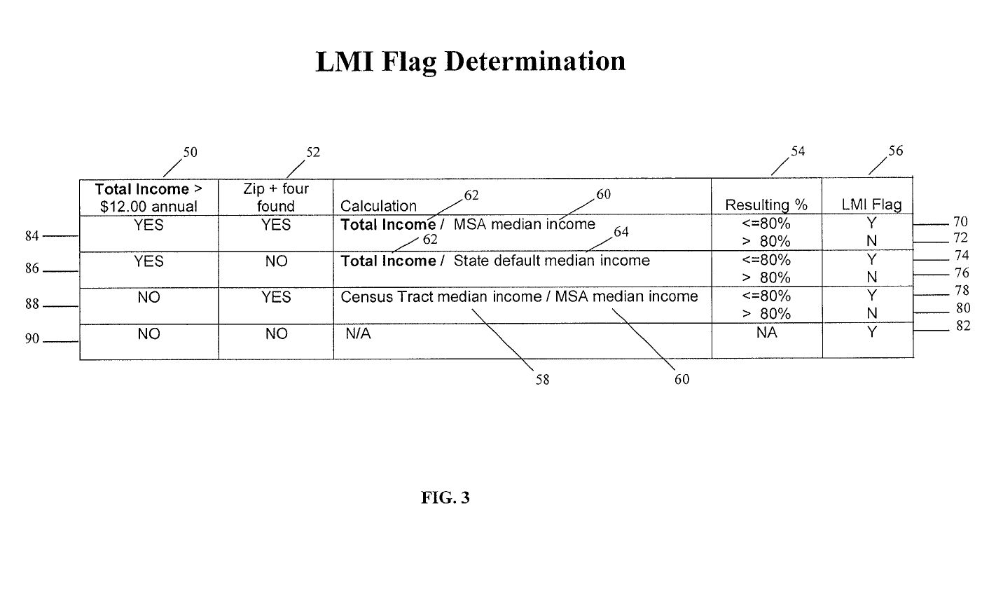

However, assume now that the applicant goes through the ‘non-established’ check for an embodiment of the present invention and is found to have a robust credit bureau history. In that case, the applicant is determined to be “established” and goes through a low-moderate income check. FIG. 3 is a table which shows an example of low-moderate income indicator (“LMI flag”) determination for the census tract method for identifying low-moderate income applicants for credit for an embodiment of the present invention. In the low-moderate income check, the financial institution retrieves the “zip plus 4” information 52 for the applicant via an interface to software, such as the “Finalist” application 12. If the applicant's income is blank (i.e., income is not furnished and thus less than $12.00 annual), the “zip plus 4” information 52 is used to perform a table lookup to obtain the census tract median income 58 and the MSA median income 60, and the lookup table information is used to determine the LMI flag 56. The LMI flag 56 is set to identify whether or not the applicant is low-moderate income. The LMI flag 56 is defined as the applicant's income 62 is less than or equal to 80% of the MSA median income 60. If a “zip plus 4” code 32 is not returned, the primary borrower's state of residence determines a default MSA median income 64 for that state. A chart is used, and the financial institution's automated credit application processing system (“ACAPS”) determines the LMI flag 56 for each borrower within an application according to a pre-defined chart.

Referring further to FIG. 3, the table illustrates examples of determination of the LMI flag 56 and sets up all of the flags. All of the borrowers within the application are evaluated as to whether they qualify for the LMI scorecard or not. On the table, the total income 50 must be greater than $12 annually, for example, because the financial institution has a value in its processing system that sets $1 per month for processing for a purpose which is unrelated to an embodiment of the present invention and is simply to assure that an amount greater than $12 is used. Referring again to FIG. 3, a first condition is whether the applicant's total income 50 is greater than $12 and whether the “zip plus 4” 52 is found. It is noted that the “zip plus 4” 52 is found for almost all situations, but a default is needed in the few cases where, for example, a system, such as the “Finalist” system 12 may be down and/or unavailable. Thus, in the first line 84 of the table, the “zip plus 4” 52 is found, and the total income 62 is divided by the MSA median income 60 in the case where the applicant provides his or her income to the financial institution. If the resulting percent 54 is less than 80% of the MSA median income 60, the LMI flag 56 is set to “Yes” 70 and if the resulting percent 54 is greater than 80%, the LMI flag 56 is set to “No” 72.

Referring once more to FIG. 3, the second line 86 on the table references a situation in which the applicant has a total income 50 greater than $12, but a “zip plus 4” 52 is not found. In that case, the applicant's total income 62 is divided by the state default median income 64, which is a default calculation. Likewise, if the resulting percent is less than 80% of the median 64, the LMI flag 56 is set to “Yes” 74, and if the resulting percent is greater than 80%, the LMI flag 56 is set to “No” 76. In the third line 88 of the table, the total income 50 is not greater than $12 annually, which represents the situation in which an applicant may not give the applicant's income to the financial institution's system at the beginning of the process. If the applicant does not give his or her income, but the “zip plus 4” 52 is found, that invokes dividing the census tract median income 58 by the MSA median income 60, and if less than 80%, the LMI flag 56 is set to “Yes” 78, or if greater than 80%, the LMI flag 56 is set to “No” 80. The applicant can furnish the applicant's income to the financial institution after the process commences. In that case, the financial institution tests to make sure whether the applicant re-qualifies for low-moderate income status. If so, the financial institution qualifies the applicant. However, when the applicant first comes into a financial center of the financial institution's system with no income to enter on the table, but with “zip plus 4” information 52 available, the applicant is initially classified accordingly. In the fourth line 90 of the table of FIG. 3, if the applicant has total income 50 less than $12 and no “zip plus 4” information 52 is found, no calculation is done, but the LMI flag 56 is set to “Yes” 82, meaning that the financial institution assumes that the applicant is low-moderate income.

In an embodiment of the present invention, if the financial institution changes the scorecards and the applicant passes the new cut-off, the applicant is given whatever credit is approved according to the new scorecard. In order to maintain the consistency of the credit qualified decision, the determination of the LMI flag 56 should be executed only once at the time of data completion activity. This means that once an applicant requests credit, as income is reviewed during the verification phase, the LMI flag 56 can be reset, and as a result, the scorecard has a potential of being different than at the beginning of the process. In other words, once the applicant gives the financial institution his or her income, the financial institution establishes that as the scorecard which will be used as the population. When verification is complete, the income is requested once the applicant wants to apply for a credit product. Once the applicant provides the financial institution with the applicant's income amount, the financial institution sets the scorecard population. The financial institution may decide to change scorecards in midstream on a limited basis based on specific policy guidelines, as the applicant may provide additional information, such as income, to the financial institution. Therefore the financial institution must be concerned about the fact that there is human interaction in some of the data fields and enforce strict policies. As applicants proceed down the processing stream, the financial institution wishes to remove any possibility of the applicant moving from a scorecard such that the applicant might not be eligible for credit for other reasons that may be brought into the process. This leads to customer service issues, so the financial institution allows applicants to give the financial institution their incomes on the first opportunity in order to help the financial institution set the appropriate LMI flag 56.

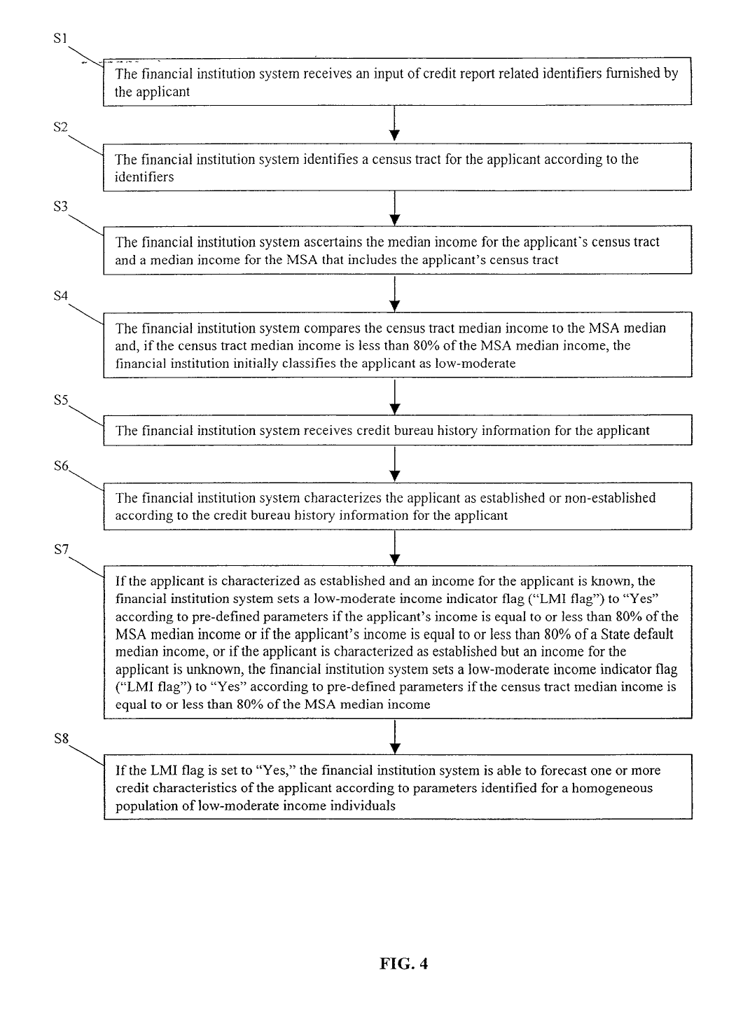

FIG. 4 is a flow chart which illustrates an example of the process of identifying, processing and credit evaluating a low-moderate income applicant for an embodiment of the present invention. Referring to FIG. 4, at S687 1, the financial institution system receives an input of credit report related identifiers furnished by the applicant. At S2, the financial institution system identifies a census tract for the applicant according to the identifiers. At S3, the financial institution system ascertains the median income for the applicant's census tract and a median income for the MSA that includes the applicant's census tract. At S4, the financial institution system compares the census tract median income to the MSA median and, if the census tract median income is less than 80% of the MSA median income, the financial institution initially classifies the applicant as low-moderate. At S5, the financial institution system receives credit bureau history information for the applicant. At S6, the financial institution system characterizes the applicant as established or non-established according to the credit bureau history information for the applicant. At S7, if the applicant is characterized as established and an income for the applicant is known, the financial institution system sets a low-moderate income indicator flag (“LMI flag”) to “Yes” according to pre-defined parameters if the applicant's income is equal to or less than 80% of the MSA median income or if the applicant's income is equal to or less than 80% of a State default median income, or if the applicant is characterized as established but an income for the applicant is unknown, the financial institution system sets a low-moderate income indicator flag (“LMI flag”) to “Yes” according to pre-defined parameters if the census tract median income is equal to or less than 80% of the MSA median income. At S8, if the LMI flag is set to “Yes,” the financial institution system is able to forecast one or more credit characteristics of the applicant according to parameters identified for a homogeneous population of low-moderate income individuals.

An embodiment of the present invention makes use of computer software and a mainframe computer 10 to systematically identifying an individual's census tract, because that is how the financial institution identifies the individual as low-moderate income and determines how to deal with the individual on his or her different circumstances within that identification. The system and method for an embodiment of the present invention can be used on those customers coming to the financial institution, as well as direct mail at a credit bureau or any other area, and its use is not necessarily limited to someone seeking credit. Considering the postulation that different populations of different economic strata have somewhat unique characteristics about the way they handle and manage credit, an embodiment of the present invention provides a methodology for identifying people of low-moderate income versus those that are not. An embodiment of the present invention focuses on homogenizing or putting together in one group a population of similar characteristics on which to develop an analytical tool. An approach of an embodiment of the present invention to providing an improved analytical tool is to develop it on a very homogeneous population. Accurately identifying and creating specialized analytical tools for specified homogeneous populations ensures that those particular populations will have the best opportunity for proper credit evaluation among their peers. Being able to identify and separate homogeneous populations provides a better overall way of analyzing and forecasting, for example, the likelihood that a loan that the financial institution makes will become good, delinquent or a collection problem.

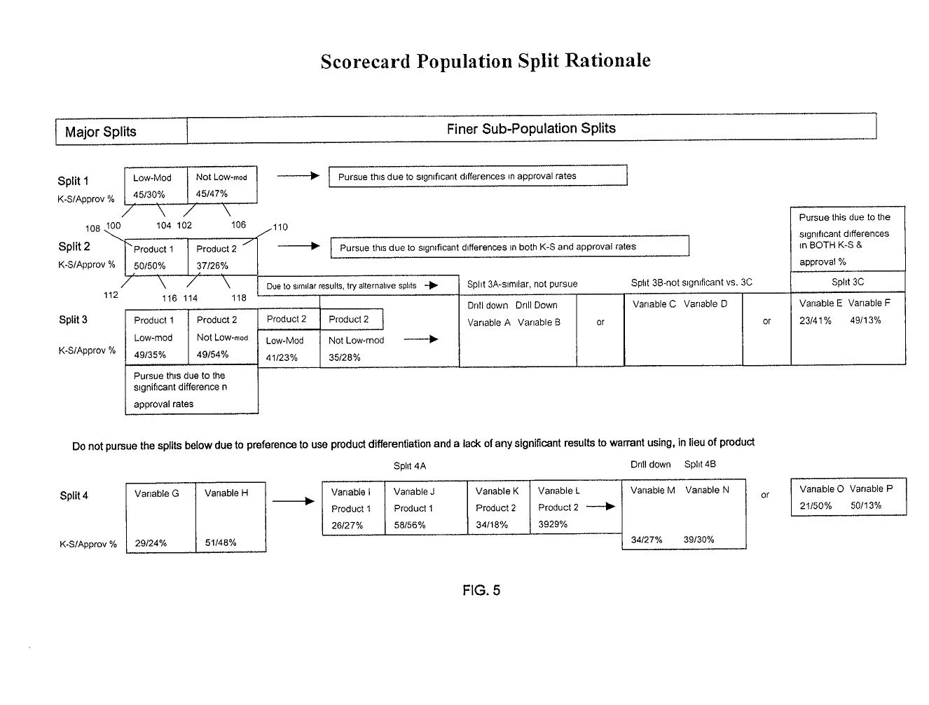

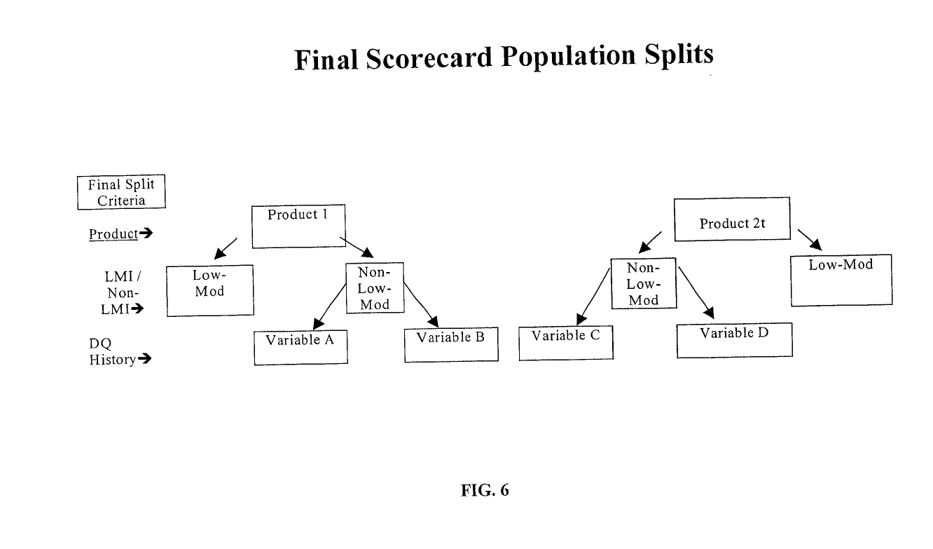

FIG. 5 is a chart which shows an example of scorecard population split rationale for the census tract method for identifying low-moderate income applicants for credit for an embodiment of the present invention. FIG. 6 is a chart which shows an example of final scorecard population splits for the census tract method for identifying low-moderate income applicants for credit for an embodiment of the present invention. FIGS. 5 and 6 illustrate examples of the results of analysis, for example, of various credit bureau characteristics of different types of groups of applicants, both in terms of products as well as low-moderate income structure. Once low-moderate income populations can be accurately identified, more traditional credit evaluating tools, such as credit bureau characteristics, can be refined to clearly forecast homogeneously separate population classifications. A purpose of the analysis for an embodiment of the present invention is to determine whether low-moderate income versus non-low-moderate income actually gives distinctly different populations. FIG. 5 reflects the results of a split analysis, the purpose of which is to identify populations that, in fact, have different approval rates as well as different good versus bad or K-S measure statistics. K-S statistics is a measure of the differences in cumulative distribution of accounts booked in the past, for example, by a financial institution, such as a bank, that have been good versus the ones booked in the past that have been bad.

Referring to FIG. 5, what is sought are distinct differences in populations, which are found and identified as Splits 1-4 labeled on the left-hand side of the table. Referring to Split 1, it is found that comparing low-moderate income versus non-low-moderate income, the K-S statistic 100, 102 is equivalent, but there are differences in terms of the approval rate 104, 106 which is much different. Therefore, based simply on Split 1, it is found that there are likely to be significant differences in the populations. Split 2 represents an understanding of differences between the financial institution's products. For example, a financial institution offers two unsecured products 108, 110, such as a revolving line of credit product and a loan product. On Split 2, there are very different K-S statistics 112, 114 and very different approval rates 116, 118. The combination, after performing this data mining, involves setting upon the task of actually combining those splits into both a low-moderate and non-low-moderate and then a product split. Split 3 is an attempt to determine whether, because of a sizable population that is non-low-moderate income (although many applicants are still low-moderate income), splitting on the basis of whether people that were non-low-moderate were ever delinquent was another appropriate step. The diagram of FIG. 6 is a pictorial representation of examples of final scorecard population splits. The problem is identified and data mining is performed to determine whether the approach for an embodiment of the present invention is both intuitive and actually meets the business objective that the financial institution wants to accomplish. When that is assessed, the financial institution can set out to go into its model development area and develop specific models for these specific populations that are somewhat at the end of the node. The financial institution utilizes data mining and analysis of what its data tells it to address as a solution to the issue of how to split the populations. Up to this point, the process is all testing and empirical analytics to understand the differences in the financial institution's populations.

Upon completion of the scorecard population split analysis and recommended scorecard population splits, examples of which are illustrated in FIGS. 4 and 5, an embodiment of the present invention involves executing the solution, which is building a model or building individual models for each of these populations. In addition to mining the data to determine where the opportunities are, an embodiment of the present invention involves actually building the model once homogeneous groups have been identified. An aspect of an embodiment of the present invention is that it can be used in a pre-approval process as well. Somewhat similar to retail stores offering “instant credit,” an embodiment of the present invention is an aspect of the financial institution's granting credit somewhat instantaneously, but with appropriate information and scoring tools to execute it, so that it fits within the constraints or the capabilities of the financial institution's system. An embodiment of the present invention provides a way for the financial institution to be able to better serve that population when they come to the financial institution and ask for credit. The population split and the ultimate system logic allows the financial institution to do that. The method and system for an embodiment of the present invention is automated and makes use of software running, for example, on the financial institution's computer system. It is automated from the standpoint that the financial institution looks at the credit bureau data which provides a key driver of the financial institution's decision. An embodiment of the present invention makes use of the low-moderate income scoring segmentation or technique.

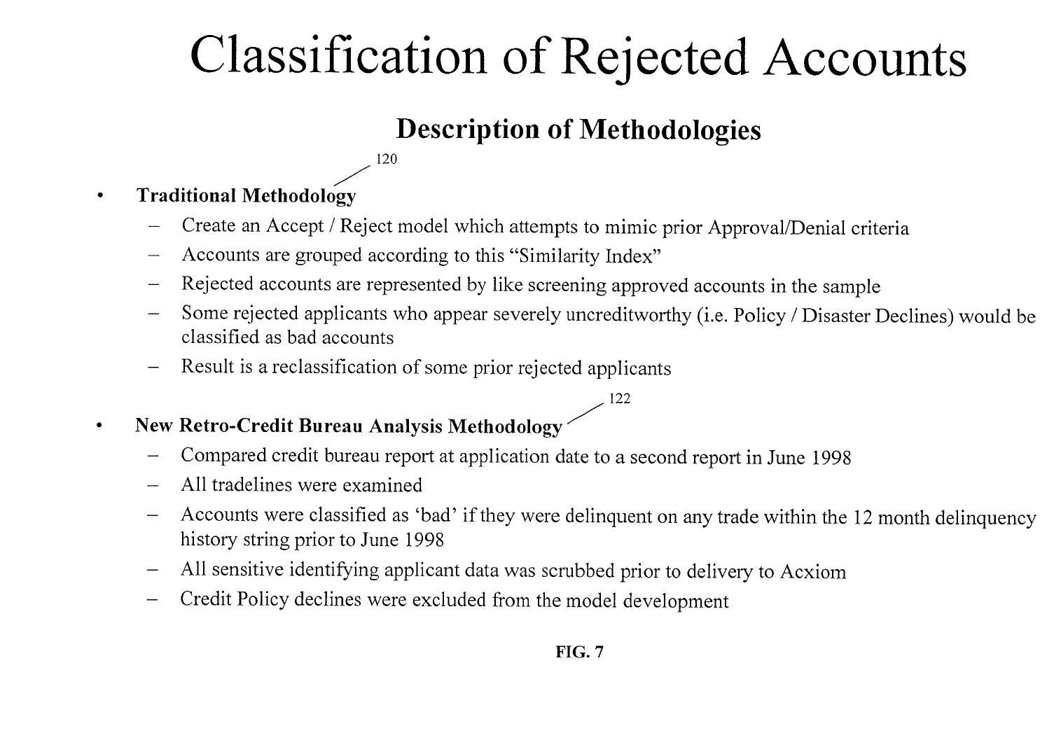

The reject inferencing aspect for an embodiment of the present invention likewise makes use of computer hardware and software to create reject inferencing for credit applicant scorecard development. FIG. 7 is a table which shows high level detail regarding description of methodologies associated with reject inferencing technologies for an embodiment of the present invention. The table of FIG. 7 deals with classification of rejected accounts and compares a methodology for a more traditional approach 120 with an example of the methodology for an embodiment of the present invention 122. The comparison can be referred to as the traditional 120 versus the new methodology 122. It helps to understand a little about the traditional methodology 120, in terms of the aim of the new methodology 122. In the reject inferencing aspect for an embodiment of the present invention, when an applicant's scorecard is developed, it is with an awareness that, as with all of the individuals that have been booked (good and bad) in the past, some will perform well and others will not perform well. In other words, it is inevitable that there will be situations where the financial institution does not know which account, out of a number of accounts, will go bad. The financial institution may only know, for example, that two accounts out of ten accounts will go bad. So the financial institution uses the scoring to recommend a decision to accept or reject. Likewise, it is realized that, in the real world, some of the previously rejected applicants would have performed perfectly well. In terms of the rejected accounts, when the financial institution develops a new scorecard, it has original application information on all of the people it has booked and rejected in the past, and it knows their characteristics at the time of the original application. In addition, it knows the credit bureau components of the rejects versus the accepts (good and bad) at the time of the original application. Further, the accepts are the people which the financial institution has booked in the past and with whom it has experience.

The traditional methodology 120 profiles the characteristics of the prior accepts (good and bad) separate from the previously rejected applications. For example, after the financial institution identifies characteristics associated with ‘good’ performance, it then goes back into the rejected application file and finds what the financial institution considers to be accounts with similar profiles that it rejected in the past for some reason. The financial institution may conclude that, since those account files look like or have a close similarity to previous accounts that were booked and were good, perhaps it made a mistake on a certain number of the rejected accounts, albeit usually a small number. The financial institution may decide that for scorecard developmental purposes it might want to now classify those particular rejected accounts having profiles similar to known good accounts as good to augment the development sample, thus providing potentially higher predictive models.

The reason that the financial institution may choose to re-classify the previously rejected accounts is that when it develops a scorecard, the financial institution needs to have a full population in its development database, including a sample of the booked accounts known to be good and bad and a sample of the rejected applications. If the financial institution includes a sample of the rejects, it must go through them in hindsight and postulate whether or not the financial institution made a mistake and question whether it should re-classify the previously rejected application as good or bad for scorecard developmental purposes. Typically, the majority of the financial institution's decisions to reject an applicant in the past are confirmed in this process, and it is not likely that a significant volume of prior rejects are reclassified as good in this traditional process 120. Usually, a small population is brought in, there are not very many large numbers of mistakes that were made in hindsight, and there is no actual performance known on the rejected applications.

The comparison of characteristics to people who have been booked in the past and who have performed well or poorly versus those characteristics associated with previously rejected applications derives an inference. That is why the term “reject inference” is used. The term “reject inference” means that the financial institution tries to infer whether some of its rejects, to whom it denied credit in the past, would have performed acceptably or not, had they been booked. This technique is used in building scorecards in order to make sure that the financial institution gets a representative sample of its entire population in the scorecard development. Thus, in the traditional methodology 120, the financial institution does not know the actual subsequent performance of rejected applications, because it has no information or performance data for rejects and therefore relies solely on characteristic comparisons for reject inferencing.

The reject inferencing aspect of the method and system for an embodiment of the present invention provides a methodology that enables the financial institution to make a better inference of whether people it has previously rejected perform well or poorly with subsequent credit extended by other creditors. Typically, the only data which the financial institution has on rejected applications is the application and credit bureau detail that the financial institution had at the time of the original application for credit for which the financial institution made the decision to reject. What the financial institution seeks in the methodology for an embodiment of the present invention is directed to obtaining actual performance, either good or bad, of subsequent credit extensions by other creditors on those applications previously rejected by the financial institutution. The methodology for an embodiment of the present invention focuses on ascertaining the ultimate performance of previously rejected applicants and then using that information to augment the financial institution's database for scorecard model development.

In the reject inferencing aspect of an embodiment of the present invention, the financial institution, for example, contracts with a third party outside the financial institution to go to the credit bureau on behalf of the financial institution. The financial institution has all of its previously rejected applications, so it knows the identifiers for the previously rejected applications exactly. The credit bureau archives all consumers' credit bureau data every month, and in that process, the financial institution knows that there is an archive for every month. The financial institution has applicants that were rejected in its sample over a staggered period of time. It takes those rejects on which it wants to make an inference, and sends them to the credit bureau via a third party vendor with identifier information. The credit bureau can match up to the closest archive that it has on its files for which detailed credit bureau information is available. For example, if the financial institution had someone who applied for credit in December of 1996 that was rejected, the financial institution gives the identifiers to the credit bureau via the third party. The credit bureau can then pull the archived credit bureau information at the nearest point in time to the time of December 1996, which is one point in time. That represents, for example, intuition.

However, in the reject inferencing aspect for an embodiment of the present invention, the financial institution needs two points in time to enable a proper inference that reflects performance. Information is needed not only for the time that the financial institution made the decision to reject, but information is also needed to show the financial institution the profile of the applicant's credit performance with other creditors as it existed at an outcome time period, for example, in June of 1998. In other words, the financial institution needs a snapshot of the credit bureau information at two points in time. All of the identifiers are removed by the third party vendor to assure anonymity. The financial institution sends all of the detailed information it has about the applicant, and the credit bureau performs the match and identifies the specific consumer at the two points in time, such as December 1996 and June 1998. The credit bureau receives the records, so that the financial institution knows what the reject looks like at the time the financial institution made its original decision to reject the application and subsequently how the particular consumer performed with other creditors at the outcome period. However, the credit bureau strips of all the identifier information back to the third-party developer, so that it does not know any information, such as a name and address or other identifier information on any of the accounts.

In the reject inferencing aspect of an embodiment of the present invention, when the information comes back to the developer at the two points in time, it uses that data to empirically determine whether a particular reject effectively maintained good credit, for example, with another creditor after the financial institution made its original reject decision, for example in December of 1996. The financial institution then knows the actual change in the credit bureau profile for the reject between December 1996 and June 1998. In addition, another important piece of information available is the individual delinquency bucket of a twelve-month history, for example, prior to June of 1998. Without knowing the name and address or any other identifiers for the particular applicant, but knowing only that the applicant was a reject, the financial institution is able to determine by looking at the twelve months performance history whether the applicant should be classified as good or bad, based on the credit bureau data. The credit bureaus use archive files, which are simply stored files archived and which are not part of the credit bureaus' on-line systems. No inquiries are posted to the consumer's file, and the information is all for analytical purposes. From the credit bureau information at two points in time, the consultant and the model developer make a recommendation to the financial institution as to which previously rejected applicants should be classified as good or bad for scorecard model development purposes. The recommendation for classifying an applicant as good or bad must be consistent with the financial institution's normal classifications of good or bad that are used by the financial institution on all the known good and bad booked accounts.

An important objective and solution provided by the reject inferencing aspect of an embodiment of the present invention is that it tells the financial institution with greater certainty on whom it made a mistake or, in other words, whom did the financial institution reject that ultimately performed well. With that knowledge, and the available detailed information from the time the financial institution made the reject decision, albeit not the specific customer identification, but only whether a reject performed well or poorly, the financial institution takes the detailed data that it knows about the reject, excluding the identification of the reject, and factors that information into the financial institution's scorecard model development process, in order to improve the predictive value of the financial institution's scorecard. Thus, the reject inferencing aspect for an embodiment of the present invention eliminates a degree of judgment and guesswork on whether the financial institution thinks someone would have retrospectively been good or bad under traditional methodology 120. It allows the financial institution to actually relate a performance outcome at the credit bureau for previously rejected applications to the various characteristics that existed at the time the rejected applicant applied with the financial institution. An important aspect of building models for an embodiment of the present invention is maintaining the data integrity and historical archive capability of the financial institution's own information when it makes a decision.

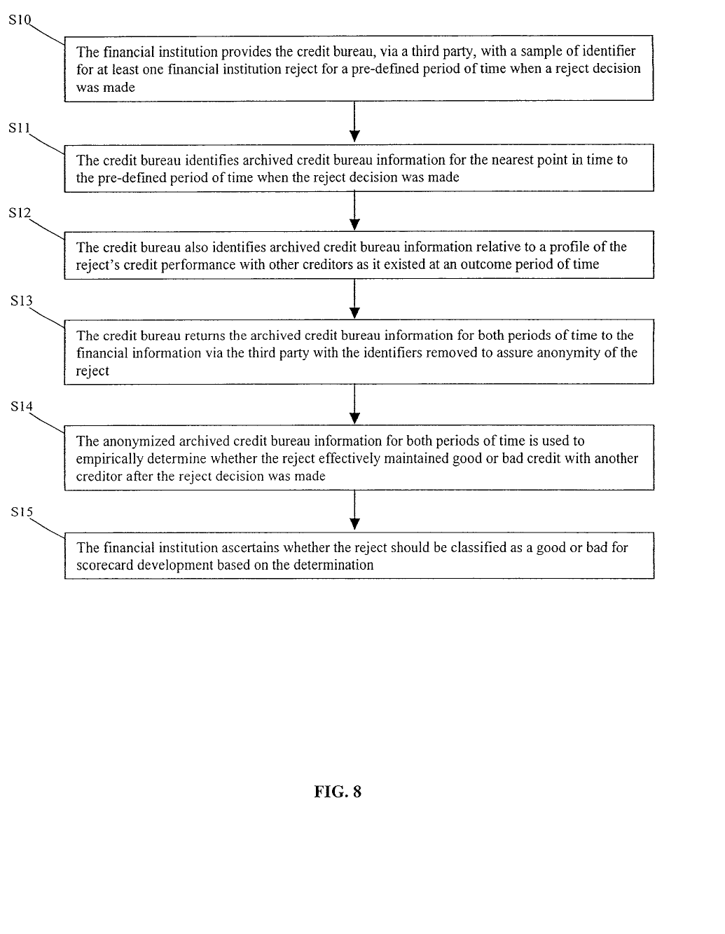

FIG. 8 is a flow chart which illustrates an example of the process of retroactively analyzing the credit performance of a credit applicant for an embodiment of the present invention. Referring to FIG. 8, at S10, the financial institution provides the credit bureau, via a third party, with a sample of identifier for at least one financial institution reject for a pre-defined period of time when a reject decision was made. At S11, the credit bureau identifies archived credit bureau information for the nearest point in time to the pre-defined period of time when the reject decision was made. At S12, the credit bureau also identifies archived credit bureau information relative to a profile of the reject's credit performance with other creditors as it existed at an outcome period of time. At S13, the credit bureau returns the archived credit bureau information for both periods of time to the financial information via the third party with the identifiers removed to assure anonymity of the reject. At S14, the anonymized archived credit bureau information for both periods of time is used to empirically determine whether the reject effectively maintained good or bad credit with another creditor after the reject decision was made. At S15, the financial institution ascertains whether the reject should be classified as a good or bad for scorecard development based on the determination.

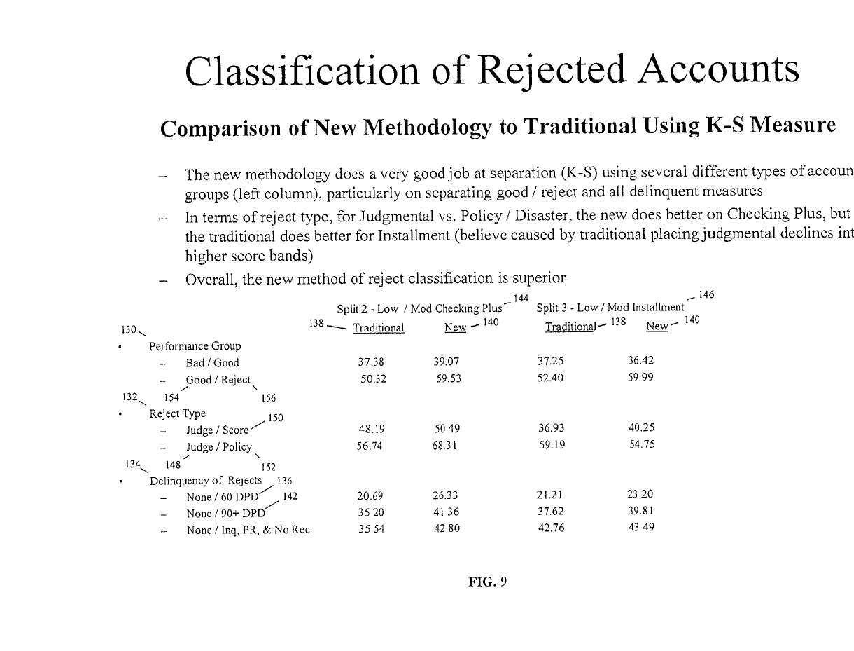

FIG. 9 is a chart which shows high level detail regarding comparison of traditional methodology 120 for reject inferencing to the methodology for reject inferencing for an embodiment of the present invention. The chart of FIG. 9 includes a sample comparison of the traditional methodology 120 with new methodology for an embodiment of the present invention, such as new methodology 122, and quantifies ways in which the methodology for an embodiment of the present invention is superior. In terms of defining the level of superiority, the financial institution tests on the basis of “performance group” 130, “reject type” 132 and “delinquency of rejects” 134. Referring to “delinquency of rejects” 134, the methodology for an embodiment of the present invention does an excellent job at separation (K-S) against the several types of account groups. The chart of FIG. 9 illustrates, for example, that the methodology for an embodiment of the present invention has higher separation power in almost all areas compared to the traditional methodology 120. Referring to “delinquency of rejects” 134, the first item is “None” versus “60 DPD” (or sixty days or more past due) 136. There are two different distributions present, namely those that have never been delinquent and those that have been delinquent 60 days or more. The objective is to try to separate those distributions based on two scorecards, one of which is built in the traditional way 138 and one of which is built according to the new way 140 for an embodiment of the present invention.

Referring again FIG. 9, the chart showing a higher separation indicates that use of the methodology for an embodiment of the present invention distributes people with prior delinquency to one end of the distribution and people without subsequent delinquency to the other end of the distribution to a greater degree. An important function of credit scoring is that it separates the distribution of different types of groups. Referring once more to the FIG. 9, for the new reject inferencing methodology 140, under “delinquency of rejects” 134, the K-S separation between “None” versus “90+DPD” (or 90 days or more past due) 142, is significantly greater for the two populations used to validate an embodiment of the present invention, namely the low/moderate checking plus (or revolving account) 144, and the low/moderate installment (or loan account) 146. So, in terms of separating these accounts 144, 146 by their delinquency, the method for an embodiment of the present invention is superior.

Referring still again to FIG. 9, under “reject type” 132, there are, for example, three different types of rejects, namely “judgmental” 148, “score” 150 and “policy” 152, which compare the reject type 132. The most significant reject type 132 that stands out is the “judgmental” 148 versus “policy” 152 where the K-S is higher on the “checking plus” 144 for the methodology of an embodiment of the present invention. In the case of the “installment” 146, the traditional methodology 138 does a little better, but that is probably because the traditional methodology 13 8 places judgmental declines into a higher score band. For the most part, the K-S's on the new methodology 140 is superior to the traditional methodology 138. Referring once more to FIG. 9, under “good” 154 versus “reject” 156, a comparison is shown between those that have performed well and those who would have been rejected. There is a very good separation shown, for example, of 59.53 on the scorecard for the new methodology 140 compared to 50.32 for the traditional methodology 138. The significance of the higher values for the K-S statistics is that by having higher values in the separation of the distribution, it shows that one population is actually forced one way and the other population is forced the other way. The objective in all these cases is to create maximum separation between these groups.

The entire classification process for an embodiment of the present invention allows the financial institution to assure that it will reject those that it does not want to approve, but also will approve those with whom mistakes were made in the past by rejecting them, for example, by classifying them more accurately. This is done by enabling the financial institution to re-classify many rejects with known subsequent performance to allow the detail characteristics which people had when they applied with the financial institution to come into the model in a very robust way, which helps in model development. The methodology behind the chart of FIG. 9 is designed to address the problem of scientific guesswork versus more of a known reality or retrospective knowledge of how people actually performed with other creditors. The financial institution does not have any idea who the other creditors are and does not even know the identity of the applicant when the information comes back for analysis, because the financial institution has it anonymized, which is a key aspect of an embodiment of the present invention. That is a delicate part and an unique aspect of the method and system for an embodiment of the present invention.

A unique feature of an embodiment to the present invention is the way in which the financial institution is able to work with third party vendors and the credit bureaus to get the information and still maintain the confidentiality of all the information to protect the consumer. Without that confidentiality, legal issues arise. Through appropriate negotiation, documentation, control, and the use of third parties, the financial institution is able to see the ultimate performance on these accounts, instead of using the traditional approach 120. In the traditional way of scoring, it is inferred that a low-scoring person or rejected applicant may have been bad, and the sample is augmented accordingly. Instead of following that procedure, the method and system for an embodiment of the present invention involves actually seeking and finding the facts, which enables the financial institution to isolate very specific cases. The results show that the methodology for an embodiment of the present invention substantially outperforms the traditional method 120 of reject inferencing. The traditional method 120 includes much analytic art, meaning that judgment is brought to the decision of classifying or reclassifying the accounts, for example, on the part of the analyst, by running the statistics in several different ways. An embodiment of the present invention provides a great improvement over the traditional method 120.

The reject inferencing aspect of an embodiment of the present invention involves a more objective approach in which, for example, there is no real subjective judgment in the evaluation of whether a customer would have performed well or not. Instead, the issue is simply what the retro bureau profile is. If it is worse than the original bureau profile, it is classified as “bad”; and if it has not deteriorated, it is classified as “good”. An embodiment of the present invention is a very powerful tool because, for example, it makes the models more predictive. The idea for an embodiment of the present invention is that it is important for these populations to have differences, because it demonstrates that the model which is built on a fairly unique homogeneous group and the model that is customized to each of these homogeneous groups allows the financial institution to make more precise decisions.

Various preferred embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention.

What is claimed is:

1. A method for identifying a low-moderate income applicant for credit, comprising:
receiving residence information for at least one credit applicant by a financial institution;
ascertaining a median income for a predefined geographic functional area and a median income for a predefined statistical subdivision within the predefined geographic functional area that correspond to the residence information for the applicant;
classifying the applicant as low-moderate income if the applicant's income is unknown and the median income for the statistical subdivision does not exceed a first predefined percentage of the median income for the geographic functional area; and
classifying the applicant as low-moderate income if the applicant's income is known and does not exceed a second predefined percentage of the median income for the geographic functional area.

2. The method of claim 1, wherein receiving the residence information further comprises receiving address information for the applicant including a corresponding postal zip code number.

3. The method of claim 2, wherein receiving the residence information further comprises receiving a corresponding nine digit postal zip code number.

4. The method of claim 1, wherein ascertaining the median income for the predefined geographic functional area further comprises ascertaining the median income for a Metropolitan Statistical Area (“MSA”) that corresponds to the residence information for the applicant.

5. The method of claim 1, wherein ascertaining the median income for the predefined statistical subdivision further comprises ascertaining the median income for a census tract that corresponds to the residence information for the applicant.

6. The method of claim 1, wherein ascertaining the median income for the predefined geographic functional area and the median income for the predefined statistical subdivision further comprises identifying the predefined geographic functional area and the predefined statistical subdivision according to the residence information.

7. The method of claim 6, wherein ascertaining the median income for the predefined geographic functional area and the median income for the predefined statistical subdivision further comprises identifying a MSA and a census tract corresponding to a nine digit postal zip code number of the residence information.

8. The method of claim 1, wherein classifying the applicant as low-moderate income if the applicant's income is unknown further comprises classifying the applicant as low-moderate income if the applicant's income is unknown and the median income for the statistical subdivision does not exceed 80 percent of the median income for the geographic functional area.

9. The method of claim 8, wherein classifying the applicant as low-moderate income if the applicant's income is unknown further comprises classifying the applicant as low-moderate income if the applicant's income is unknown and the median income for a census tract that corresponds to the residence information for the applicant does not exceed 80 percent of the median income for a MSA that corresponds to the residence information for the applicant.

10. The method of claim 1, wherein classifying the applicant as low-moderate income if the applicant's income is unknown further comprises comparing the median income for the statistical subdivision to the median income for the geographic functional area.

11. The method of claim 1, wherein classifying the applicant as low-moderate income if the applicant's income is unknown further comprises comparing the median income for a census tract that corresponds to the residence information for the applicant to the median income for a MSA that corresponds to the residence information for the applicant.

12. The method of claim 1, wherein classifying the applicant as low-moderate income if the applicant's income is unknown further comprises setting a low-moderate income indicator flag to “YES.”

13. The method of claim 1, wherein classifying the applicant as low-moderate income if the applicant's income is known further comprises classifying the applicant as low-moderate income if the applicant's income is known and does not exceed 80 percent of the median income for the geographic functional area.

14. The method of claim 13, wherein classifying the applicant as low-moderate income if the applicant's income is known further comprises classifying the applicant as low-moderate income if the applicant's income is known and does not exceed 80 percent of the median income for a MSA that corresponds to the residence information for the applicant.

15. The method of claim 1, wherein classifying the applicant as low-moderate income if the applicant's income is known further comprises classifying the applicant as low-moderate income if the applicant's income is known and does not exceed 80 percent of the median income for a state that corresponds to the residence information for the applicant.

16. The method of claim 1, wherein classifying the applicant as low-moderate income if the applicant's income is known further comprises comparing the applicant's income to the median income for the geographic functional area.

17. The method of claim 1, wherein classifying the applicant as low-moderate income if the applicant's income is known further comprises comparing the applicant's income to the median income for a MSA that corresponds to the residence information for the applicant.

18. The method of claim 1, wherein classifying the applicant as low-moderate income if the applicant's income is known further comprises comparing the applicant's income to the median income for a state that corresponds to the residence information for the applicant.

19. The method of claim 1, wherein classifying the applicant as low-moderate income if the applicant's income is known further comprises setting a low-moderate income indicator flag to “YES.”

20. The method of claim 1, further comprising forecasting at least one credit characteristic of the low-moderate income applicant according to predefined parameters for a homogeneous population of low-moderate income credit applicants.

21. The method of claim 1, further comprising deriving an inference of at least one credit characteristic of the low-moderate income applicant from a comparison of characteristics of other applicants to whom credit was extended by the financial institution in the past versus those characteristics associated with previously rejected applicants of the financial institution to whom credit was subsequently extended by other creditors.

22. The method of claim 21, wherein deriving the inference further comprises providing a credit bureau with a sample of identifiers for previously rejected applicants of the financial institution for a predefined period of time when the applicants were rejected.

23. The method of claim 22, wherein deriving the inference further comprises providing the credit bureau with the sample of identifiers via a third party service provider.

24. The method of claim 22, wherein deriving the inference further comprises identifying first archived credit bureau information for the nearest point in time to the predefined period of time when the applicants were rejected.

25. The method of claim 24, wherein deriving the inference further comprises identifying second archived credit bureau information relative to a profile of the credit performance of the previously rejected applicants with the other creditors.

26. The method of claim 25, wherein deriving the inference further comprises returning the first and second archived credit bureau information to the financial institution with identifiers removed for anonymity of the previously rejected applicants.

27. The method of claim 26, wherein deriving the inference further comprises returning the first and second archived credit bureau information to the financial institution via a third party service provider.

28. The method of claim 26, wherein deriving the inference further comprises empirically determining from the anonymized first and second archived credit bureau information whether the previously rejected applicants subsequently maintained good credit with the other creditors.

29. A system for identifying a low-moderate income applicant for credit, comprising:
means for receiving residence information for at least one credit applicant by a financial institution;
means for ascertaining a median income for a predefined geographic functional area and a median income for a predefined statistical subdivision within the predefined geographic functional area that correspond to the residence information for the applicant;
means for classifying the applicant as low-moderate income if the applicant's income is unknown and the median income for the statistical subdivision does not exceed a first predefined percentage of the median income for the geographic functional area; and
means for classifying the applicant as low-moderate income if the applicant's income is known and does not exceed a second predefined percentage of the median income for the geographic functional area.

30. The system of claim 29, wherein the means for receiving the residence information further comprises means for receiving address information for the applicant including a corresponding postal zip code number.

31. The system of claim 30, wherein the means for receiving the residence information further comprises means for receiving a corresponding nine digit postal zip code number.

32. The system of claim 29, wherein the means for ascertaining the median income for the predefined geographic functional area further comprises means for ascertaining the median income for a Metropolitan Statistical Area (“MSA”) that corresponds to the residence information for the applicant.

33. The system of claim 29, wherein the means for ascertaining the median income for the predefined statistical subdivision further comprises means for ascertaining the median income for a census tract that corresponds to the residence information for the applicant.

34. The system of claim 29, wherein the means for ascertaining the median income for the predefined geographic functional area and the median income for the predefined statistical subdivision further comprises means for identifying the predefined geographic functional area and the predefined statistical subdivision according to the residence information.

35. The system of claim 34, wherein the means for ascertaining the median income for the predefined geographic functional area and the median income for the predefined statistical subdivision further comprises means for identifying a MSA and a census tract corresponding to a nine digit postal zip code number of the residence information.

36. The system of claim 29, wherein the means for classifying the applicant as low-moderate income if the applicant's income is unknown further comprises means for classifying the applicant as low-moderate income if the applicant's income is unknown and the median income for the statistical subdivision does not exceed 80 percent of the median income for the geographic functional area.

37. The system of claim 36, wherein the means for classifying the applicant as low-moderate income if the applicant's income is unknown further comprises means for classifying the applicant as low-moderate income if the applicant's income is unknown and the median income for a census tract that corresponds to the residence information for the applicant does not exceed 80 percent of the median income for a MSA that corresponds to the residence information for the applicant.

38. The system of claim 29, wherein the means for classifying the applicant as low-moderate income if the applicant's income is unknown further comprises means for comparing the median income for the statistical subdivision to the median income for the geographic functional area.

39. The system of claim 29, wherein the means for classifying the applicant as low-moderate income if the applicant's income is unknown further comprises means for comparing the median income for a census tract that corresponds to the residence information for the applicant to the median income for a MSA that corresponds to the residence information for the applicant.

40. The system of claim 29, wherein the means for classifying the applicant as low-moderate income if the applicant's income is unknown further comprises means for setting a low-moderate income indicator flag (“LMI flag”) to YES.

41. The system of claim 29, wherein the means for classifying the applicant as low-moderate income if the applicant's income is known further comprises means for classifying the applicant as low-moderate income if the applicant's income is known and does not exceed 80 percent of the median income for the geographic functional area.

42. The system of claim 29, wherein the means for classifying the applicant as low-moderate income if the applicant's income is known further comprises means for classifying the applicant as low-moderate income if the applicant's income is known and does not exceed 80 percent of the median income for a MSA that corresponds to the residence information for the applicant.

43. The system of claim 29, wherein the means for classifying the applicant as low-moderate income if the applicant's income is known further comprises means for classifying the applicant as low-moderate income if the applicant's income is known and does not exceed 80 percent of the median income for a state that corresponds to the residence information for the applicant.

44. The system of claim 29, wherein the means for classifying the applicant as low-moderate income if the applicant's income is known further comprises means for comparing the applicant's income to the median income for the geographic functional area.

45. The system of claim 29, wherein the means for classifying the applicant as low-moderate income if the applicant's income is known further comprises means for comparing the applicant's income to the median come for a MSA that corresponds to the residence information for the applicant.

46. The system of claim 29, wherein the means for classifying the applicant as low-moderate income if the applicant's income is known further comprises means for comparing the applicant's income to the median come for a state that corresponds to the residence information for the applicant.

47. The system of claim 29, wherein the means for classifying the applicant as low-moderate income if the applicant's income is known further comprises means for setting a low-moderate income indicator flag (“LMI flag”) to YES.

48. The system of claim 29, further comprising means for forecasting at least one credit characteristic of the low-moderate income applicant according to predefined parameters for a homogeneous population of low-moderate income credit applicants.

49. The system of claim 29, further comprising means for deriving an inference of at least one credit characteristic of the low-moderate income applicant from a comparison of characteristics of other applicants to whom credit was extended by the financial institution in the past versus those characteristics associated with previously rejected applicants of the financial institution to whom credit was subsequently extended by other creditors.

50. The system of claim 49, wherein the means for deriving the inference further comprises means for providing a credit bureau with a sample of identifiers for previously rejected applicants of the financial institution for a predefined period of time when the applicants were rejected.

51. The system of claim 50, wherein the means for deriving the inference further comprises means for providing the credit bureau with the sample of identifiers via a third party service provider.

52. The system of claim 50, wherein the means for deriving the inference further comprises means for identifying first archived credit bureau information for the nearest point in time to the predefined period of time when the applicants were rejected.

53. The system of claim 52, wherein the means for deriving the inference further comprises means for identifying second archived credit bureau information relative to a profile of the credit performance of the previously rejected applicants with the other creditors.

54. The system of claim 53, wherein the means for deriving the inference further comprises means for returning the first and second archived credit bureau information to the financial institution with identifiers removed for anonymity of the previously rejected applicants.

55. The system of claim 54, wherein the means for deriving the inference further comprises means for returning the first and second archived credit bureau information to the financial institution via a third party service provider.

56. The system of claim 55, wherein the means for deriving the inference further comprises means for empirically determining from the anonymized first and second archived credit bureau information whether the previously rejected applicants subsequently maintained good credit with the other creditors.

57. A method of deriving an inference of at least one credit characteristic of a low-moderate income applicant, comprising:
providing a credit bureau with an identifier via a third party service provider for at least one previously rejected low-moderate income applicant of the financial institution for a predefined period of time when the applicant was rejected;
identifying first archived credit bureau information for the nearest point in time to the predefined period of time when the previously rejected low-moderate income applicant was rejected;
identifying second archived credit bureau information relative to a profile of the credit performance of the previously rejected low-moderate income applicant with another creditor;
returning the first and second archived credit bureau information to the financial institution via the third party service provider with the identifier removed for anonymity of the previously rejected low-moderate income applicant;
empirically determining from the anonymized first and second archived credit bureau information whether the previously rejected low-moderate income applicant subsequently maintained good credit with the other creditor;
deriving an inference of at least one credit characteristic of the low-moderate income applicant from the empirical determination.
